(19) United States
(12) Patent Application Publication
(10) Pub. No.: US 2026/0173004 A1
(43) Pub. Date: Jun. 18, 2026

(54) WIRELESS SYNCHRONIZATION OF SENSORS

(71) Applicant: TEKNOLOGIAN TUTKIMUSKESKUS VTT OY, Espoo (FI)

(72) Inventors: Mohammadhossein BEHFAR, Espoo (FI); Dung NGUYEN, Espoo (FI)

(21) Appl. No.: 19/361,429

(22) Filed: Oct. 17, 2025

(30) Foreign Application Priority Data
Oct. 21, 2024 (FI) 20246251

(51) Int. Cl. H04W 56/00

(52) U.S. Cl. CPC H04W 56/0065

(57) ABSTRACT

Apparatus and method are disclosed. The solution comprises transmitting (400) to one or more biosignal sensor apparatuses a synchronization packet, the packet comprising timing data of the clock of the apparatus; receiving (402) an acknowledgement packet from the one or more biosignal sensor apparatuses, the acknowledgement packet comprising timing difference between the biosignal sensor apparatuses and the timing data of the synchronization packet and adjusting (404) frequency of synchronization packet transmission based on the timing differences received from the one or more biosignal sensor apparatuses.

### TECHNICAL FIELD

The exemplary and non-limiting embodiments of the invention relate generally to synchronization.

### BACKGROUND

Measurements of physiological parameters using sensor devices is common in many applications, including healthcare and sports, for example. Single sensor devices provide data from a given part of the subject's body. It would be advantageous to perform measurements with multiple devices simultaneously. That would increase the accuracy of the measurements and provide more information on physiological parameters

Typically, the devices need to be synchronized so that the measurement results can be combined. Conventionally, the synchronization is realized by connecting the devices using a wire to synchronize their clocks. This limits the usability of multisensory measurements as mobility is severely limited.

### BRIEF DESCRIPTION

According to an aspect of the present invention, there are provided apparatuses of claims 1 and 8.

According to an aspect of the present invention, there are provided methods of claims 9 and 14.

According to an aspect of the present invention, there are provided computer programs of claims 15 and 16.

The scope of protection sought for various embodiments of the invention is set out by the independent claims.

The embodiments and or examples and features, if any, described in this specification that do not fall under the scope of the independent claims are to be interpreted as examples useful for understanding various embodiments of the invention.

### BRIEF DESCRIPTION OF THE DRAWINGS

In the following the invention will be described in greater detail by means of preferred embodiments with reference to the accompanying drawings, in which

FIGS. 1A and 1B illustrate examples of a system in which embodiments of the invention may be utilised;

FIGS. 2 and 3 illustrate simplified examples of apparatuses applying some embodiments;

FIGS. 4 and 5 are flowcharts illustrating embodiments and

FIG. 6 illustrates an example of synchronous measurements.

### DETAILED DESCRIPTION OF SOME EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. All combinations of the embodiments are considered possible if their combination does not lead to structural or logical contradiction.

It should be noted that while Figures illustrate various embodiments, they are simplified diagrams that only show some structures and/or functional entities. The connections shown in the Figures may refer to logical or physical connections. It is apparent to a person skilled in the art that the described biosignal measurement apparatus may also comprise other functions and structures than those described in Figures and text. It should be appreciated that details of some functions, structures, and the signalling used for measurement and/or controlling are irrelevant to the actual invention. Therefore, they need not be discussed in more detail here.

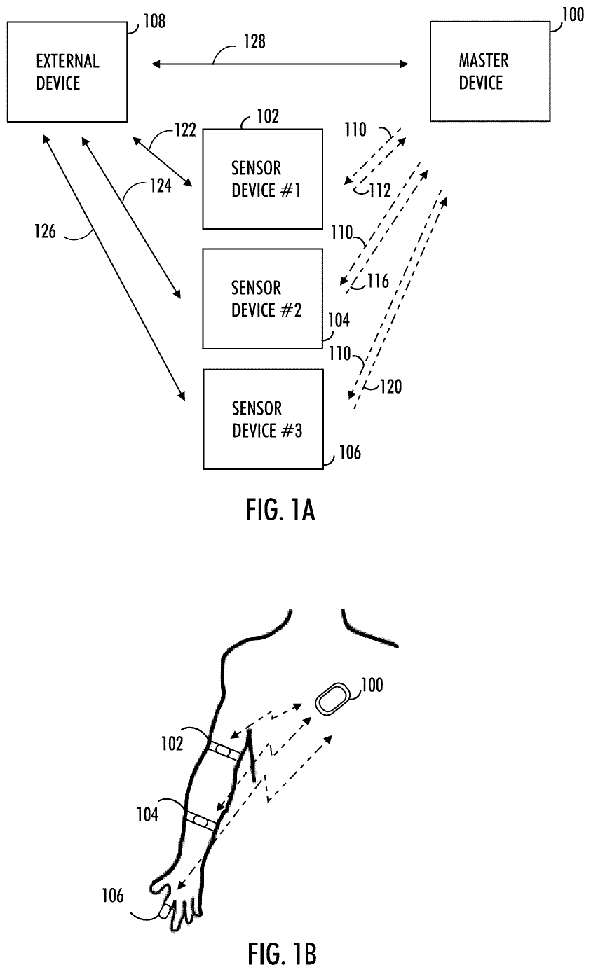

FIGS. 1A and 1B illustrate example of a system in which embodiments of the invention may be utilised. The embodiments are not, however, restricted to the system given as an example but a person skilled in the art may apply the solution to other systems provided with necessary properties. The system comprises a master or controller apparatus or device 100, and a number of slave or controllable apparatuses or devices 102, 104, 106. Here the number of the slave or controllable apparatuses or devices is three, but the number of apparatuses is not limited to any particular number but may be anything from one upwards. In an embodiment, the slave or controllable apparatuses may be sensor apparatuses, more specifically biosignal sensor apparatuses. The system may also comprise an external device 108, which may be a personal computer, user equipment, mobile phone, a data processing device or a receiver connected to a data processing device.

In an embodiment, the biosignal sensor apparatuses 102, 104, 106 are configured to perform biosignal measurement utilising one or more sensors. The apparatuses may perform photoplethysmography (PPG) measurements, for example. In PPG, non-invasive optical measurements are used to detect volumetric changes in blood in peripheral circulation. A PPG sensor can measure heart pulses so it can measure heart rate and heart rate variation, pulse amplitude and its variations. PPG utilizes low-intensity infrared (IR) light. As this light passes through biological tissues, it is absorbed by various components such as bones, skin pigments, and both venous and arterial blood. Due to the higher absorption of light by blood compared to surrounding tissues, PPG sensors can detect changes in blood flow by monitoring alterations in light intensity. The voltage signal obtained from PPG is directly proportional to the amount of blood moving through the blood vessels. PPG is mentioned here only as an example, the biosignal sensor apparatuses 102, 104, 106 may be configured to perform other kind of measurements in a similar manner.

In an embodiment, the biosignal sensor apparatuses 102, 104, 106 are configured to transmit measurements results to the external device 108 using a wireless connection, such as Bluetooth™ or Bluetooth™ Low Energy, for example. Also other Radio Frequency, RF, or wireless protocols are possible, as one skilled in the art is aware. In addition, optical and acoustic wireless communication are also possible, for example. As a non-limiting example, biosignals may be related to bio-impedance, body temperature, body hydration, derivative from the PPG signal such as heart rate, level of blood oxygenation, biochemical sensing.

In an embodiment, also the master apparatus 100 is configured to perform biosignal measurement utilising one or more sensors. For example, the master apparatus 100 may measure heart signal by producing an electrocardiogram (ECG or EKG), a recording of the heart's electrical activity. The master apparatus 100 configured to transmit measurements results to the external device 108 using a wireless connection, such as Bluetooth™ or Bluetooth™ Low Energy, for example. Also other wireless protocols are possible, as one skilled in the art is aware.

As FIG. 1B illustrates, the master apparatus 100 and the biosignal sensor apparatuses 102, 104, 106 may be attached to a person in different parts of the person's body to perform measurements.

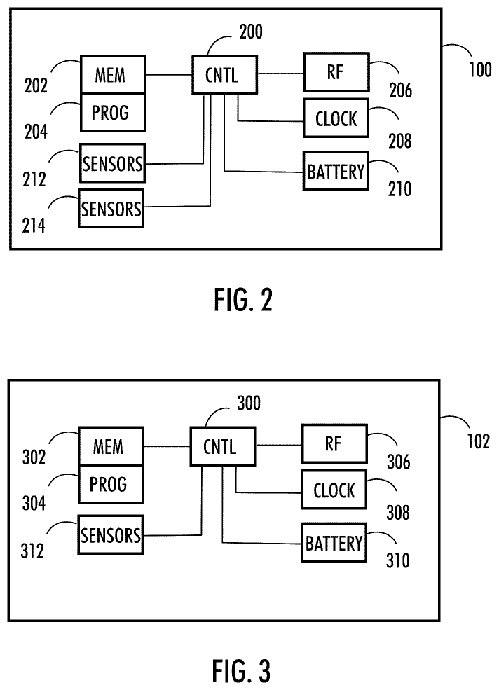

FIGS. 2 and 3 illustrate an embodiment. FIG. 2 illustrates a simplified example of the master apparatus 100 and FIG. 3 illustrates a simplified example of a biosignal sensor apparatus 102, 104, 106, applying some embodiments of the invention. It should be understood that the apparatuses are depicted herein as example illustrating some embodiments. It is apparent to a person skilled in the art that the apparatuses may also comprise other functions and/or structures and not all described functions and structures are required. Although the apparatuses have been depicted as one entity, different modules and memory may be implemented in one or more physical or logical entities. The apparatuses may be realised in various ways.

The apparatus 100 of the example of FIG. 2 includes a control circuitry 200 configured to control at least part of the operation of the apparatus.

The apparatus may comprise a memory 202 for storing data. Furthermore, the memory may store software 204 executable by the control circuitry 200. The memory may be integrated in the control circuitry.

The apparatus further comprises an interface circuitry 206 which may be a set of wireless transceivers configured to communicate with the biosignal sensor apparatus 102, 104, 106, and with the external device 108. The interface circuitry may be connected to an antenna arrangement (not shown). The apparatus may also comprise a connection to a transceiver instead of a transceiver.

In an embodiment, the software 204 may comprise a computer program comprising program code means adapted to cause the control circuitry 200 of the apparatus to realise at least some of the embodiments described below.

The apparatus further comprises a clock or a real-time clock 208 and a battery or a power source 210.

In an embodiment, the apparatus may further comprise one or more sensors 212 for performing biosignal measurements.

In an embodiment, the apparatus may further comprise or is connected to one or more ambient sensors 214 for performing measurements from surroundings. Non-limiting examples of this kind of measurements are temperature, humidity, vibration, acceleration and proximity.

The apparatus 102 (or 104, 106) of the example of FIG. 3 includes a control circuitry 300 configured to control at least part of the operation of the apparatus. The overall structure of the apparatus 102 is similar to the apparatus of FIG. 2.

The apparatus may comprise a memory 302 for storing data. Furthermore, the memory may store software 304 executable by the control circuitry 300. The memory may be integrated in the control circuitry.

The apparatus further comprises an interface circuitry 306 which may be a set of wireless transceivers configured to communicate with the master apparatus 100 and with the external device 108. The interface circuitry may be connected to an antenna arrangement (not shown). The apparatus may also comprise a connection to a transceiver instead of a transceiver.

In an embodiment, the software 304 may comprise a computer program comprising program code means adapted to cause the control circuitry 300 of the apparatus to realise at least some of the embodiments described below.

The apparatus further comprises a clock or a real-time clock 308 and a battery or a power source 310.

In an embodiment, the apparatus may further comprise one or more sensors 312 for performing biosignal measurements.

When biosignals or physiological parameters are measured with multiple devices or sensors, in some applications it may be important to be able to obtain measurement samples in a synchronous manner, i.e., the sensors should obtain measurement samples in the same Simultaneous measurements of physiological parameters require that the measuring devices are synchronized in sampling time. Conventionally, the synchronization is realized by connecting the devices using wire to synchronize their clocks. This wired connectivity has a drawback of limited mobility in everyday life applications.

The proposed solution comprises a system architecture that enables wireless synchronization of multiple distributed sensors against a master apparatus. The solution is able to measure and compensate the time drift between the sensors.

In the proposed solution the master device 100 is configured to wirelessly control the operation and the clocks of the sensor apparatuses.

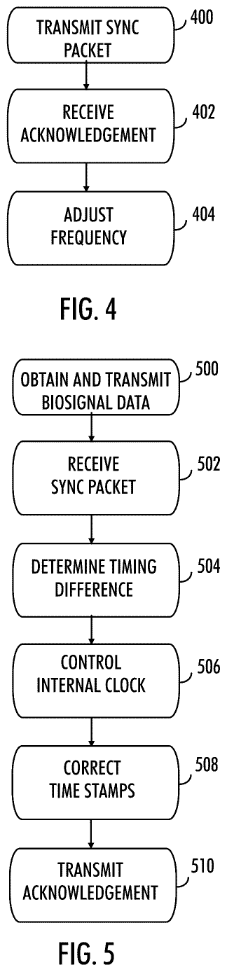

FIG. 4 is a flowchart illustrating an embodiment. The flowchart illustrates the operation of the apparatus acting as a master apparatus for one or more biosignal sensor apparatuses.

In step 400, the apparatus is configured to control the wireless transceiver 206 to transmit to one or more biosignal sensor apparatuses a synchronization packet, the packet comprising timing data of the clock 208 of the apparatus. In an embodiment, the wireless transceiver 206 may be controlled to transmit the synchronization packet to all sensor apparatuses related to the master apparatus.

In an embodiment, the apparatus utilises ANT+ technology in communicating with the one or more biosignal sensor apparatuses. ANT+ is an open access multicast wireless sensor network technology designed for enabling communication between network nodes. ANT+-powered nodes can simultaneously function as sources or destinations within a wireless sensor network, for example. The nodes can serve as transmitters, receivers, or transceivers, facilitating the routing of data to other nodes. Furthermore, each node has the ability to decide when to transmit data by observing the activity of nearby nodes.

In step 402, the apparatus is configured to control the wireless transceiver to receive an acknowledgement packet from the one or more biosignal sensor apparatuses, the acknowledgement packet comprising timing difference between the biosignal sensor apparatuses and the timing data of the synchronization packet.

In step 404, the apparatus is configured to adjust frequency of synchronization packet transmission based on the timing differences received from the one or more biosignal sensor apparatuses.

In an embodiment, the apparatus is configured to compare the timing differences received from the one or more biosignal sensor apparatuses to a given threshold and refrain from adjusting the adjust frequency of synchronization packet transmission if the timing differences are below the threshold.

In an embodiment, the apparatus is configured to determine if acknowledgement packets from all biosignal sensor apparatuses the apparatus is controlling have been received. If one or more acknowledgement packets are missing, then the apparatus may refrain from adjusting the adjust frequency of synchronization packet transmission until acknowledgement packets have been received from all biosignal sensor apparatuses.

In an embodiment, the apparatus is configured to receive environmental data from ambient sensors and take the environmental data into account when adjusting frequency of synchronization packet transmission.

FIG. 5 is a flowchart illustrating an embodiment. The flowchart illustrates the operation of the apparatus acting as a biosignal sensor apparatus.

In step 500, the apparatus is configured to obtain biosignal data from the one or more biosignal sensors 312 and control the wireless transceiver 306 to transmit the biosignal data to an external apparatus.

In step 502, the apparatus is configured to control the wireless transceiver to receive from a master apparatus a synchronization packet, the packet comprising timing data of the clock of the master apparatus.

In step 504, the apparatus is configured to determine the timing difference between the clock 308 of the apparatus and the timing data of the synchronization packet.

In step 506, the apparatus is configured to control the clock to be in sync with the timing data of the synchronization packet.

In step 508, the apparatus is configured to correct time stamps of the obtained biosignal data based on the timing difference.

In step 510, the apparatus is configured to control the wireless transceiver to transmit an acknowledgement packet to the master apparatus, the acknowledgement packet comprising the determined timing difference.

In an embodiment, the apparatus is configured to compare the determined timing difference to a given threshold and refrain from correcting the clock if the timing difference is below the threshold.

Returning to FIG. 1A, the master apparatus 100 transmits to the biosignal sensor apparatuses 102, 104, 106 a synchronization packet 110, the packet comprising timing data of the clock of the master apparatus 100. In an embodiment, the transmission is a broadcast transmission, i.e., the same transmission is received by all the biosignal sensor apparatuses. The synchronization packet 110 comprises the timing data of the clock of the master apparatus.

As mentioned above, the biosignal sensor apparatuses are configured to receive the synchronization packet 110 and calculate the time drift between the clock of the master apparatus and their own clock. They are configured to transmit an acknowledgement 112, 116, 120 back to the master apparatus. In an embodiment, the acknowledgement comprises the identification of the biosignal sensor apparatus transmitting the acknowledgement and the calculated time drift.

In an embodiment, if the time drift of a biosignal sensor apparatus is larger than a given threshold it corrects its clock to be in sync with the clock of the master apparatus, i.e., reduce the time drift.

The biosignal sensor apparatuses are configured to obtain biosignal data from one or more biosignal sensors of the apparatuses transmit the biosignal data 122, 124, 126 to an external apparatus. In an embodiment, also the master apparatus obtains biosignal data and transmit the biosignal data 128 to the external apparatus. Because the time drifts between the clocks of the master apparatus and the biosignal sensor apparatuses are minimised, all the transmissions 122, 124, 126 and 128 are synchronised. This happens even if the apparatuses start their measurements at different times.

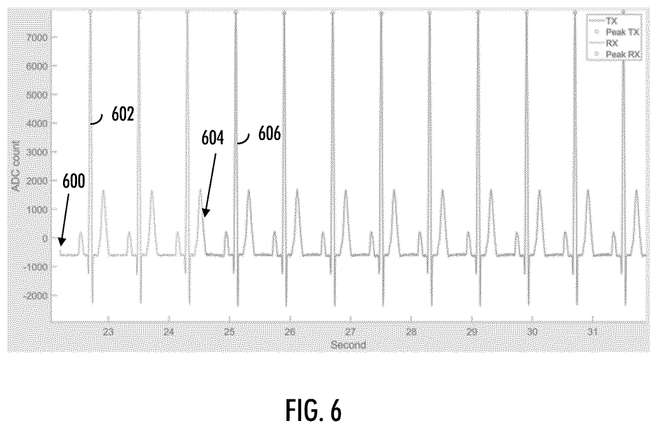

FIG. 6 illustrates an example where there are two apparatuses transmitting the measurement results to the external apparatus. Both apparatuses make same biosignal measurements.

The figure shows measurement results of two apparatuses superimposed on the same coordinate system. At time instant 600 first apparatus produces measurements 602. At time instant 604 a second apparatus produces measurements and now the two measurement results 606 are shown superimposed. As the measurements are synchronised, they are on top of each other.

In an embodiment, the processes or methods described in above figures may also be carried out in the form of one or more computer processes defined by one or more computer program. A separate computer program may be provided in one or more apparatuses that execute functions of the processes described in connection with the figures. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, which may comprise a working memory (RAM), a central processing unit (CPU), and a system clock. The CPU may comprise a set of registers, an arithmetic logic unit, and a controller. The controller is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits, ASICs. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

It will be obvious to a person skilled in the art that, as the technology advances, the inventive concept can be implemented in various ways. The invention and its embodiments are not limited to the examples described above but may vary within the scope of the claims.

1. An apparatus in a communication system, the apparatus comprising
a clock;
a wireless transceiver;
at least one processor;
at least one memory including computer program code;
the at least one memory and the computer program code configured to, with the at least one processor, cause the apparatus at least to perform:
control the wireless transceiver to transmit to one or more biosignal sensor apparatuses a synchronization packet, the packet comprising timing data of the clock of the apparatus; wherein
control the wireless transceiver to receive an acknowledgement packet from the one or more biosignal sensor apparatuses, the acknowledgement packet comprising timing difference between the biosignal sensor apparatuses and the timing data of the synchronization packet;
increase or decrease frequency of synchronization packet transmission based on the timing differences received from the one or more biosignal sensor apparatuses.

2. The apparatus of claim 1, the at least one memory and the computer program code configured to, with the at least one processor, cause the apparatus further to perform:
receive environmental data from ambient sensors;
take the environmental data into account when adjusting frequency of synchronization packet transmission.

3. The apparatus of claim 1, the at least one memory and the computer program code configured to, with the at least one processor, cause the apparatus further to perform:
increase the frequency of synchronization packet transmission if one or more of the received timing differences is greater than a given first threshold.

4. The apparatus of claim 1, the at least one memory and the computer program code configured to, with the at least one processor, cause the apparatus further to perform:
decrease the frequency of synchronization packet transmission if one or more of the received timing differences is below than a given second threshold.

5. The apparatus of claim 2, wherein the apparatus comprises ambient sensors.

6. The apparatus of claim 2, wherein the ambient sensors comprise temperature, acceleration, vibration, proximity and/or humidity sensors.

7. The apparatus of claim 1, wherein the apparatus comprises one more biosignal sensors, the at least one memory and the computer program code configured to, with the at least one processor, cause the apparatus further to perform:
obtain biosignal data from the one or more biosignal sensors and control the wireless transceiver to transmit the biosignal data to an external apparatus.

8. (canceled)

9. A method for an apparatus, comprising:
transmitting to one or more biosignal sensor apparatuses a synchronization packet, the packet comprising timing data of a clock of the apparatus; wherein
receiving an acknowledgement packet from the one or more biosignal sensor apparatuses, the acknowledgement packet comprising timing difference between the biosignal sensor apparatuses and the timing data of the synchronization packet;
increasing or decreasing frequency of synchronization packet transmission based on the timing differences received from the one or more biosignal sensor apparatuses.

10. The method of claim 9, further comprising:
receiving environmental data from ambient sensors;
taking the environmental data into account when adjusting frequency of synchronization packet transmission.

11. The method of claim 9, further comprising:
increasing the frequency of synchronization packet transmission if one or more of the received timing differences is greater than a given first threshold.

12. The method of claim 9, further comprising:
decreasing the frequency of synchronization packet transmission if one or more of the received timing differences is below than a given second threshold.

13. The method of claim 9, further comprising:
obtaining biosignal data from one or more biosignal sensors and transmitting the biosignal data to an external apparatus.

14. (canceled)

15. A computer program comprising instructions for causing an apparatus of a communication system to perform at least the following:
control a wireless transceiver to transmit to one or more biosignal sensor apparatuses a synchronization packet, the packet comprising timing data of a clock of the apparatus; wherein
control the wireless transceiver to receive an acknowledgement packet from the one or more biosignal sensor apparatuses, the acknowledgement packet comprising timing difference between the biosignal sensor apparatuses and the timing data of the synchronization packet;
increase or decrease frequency of synchronization packet transmission based on the timing differences received from the one or more biosignal sensor apparatuses.

16. (canceled)
